(19) United States
(12) Patent Application Publication
(10) Pub. No.: US 2012/0299747 A1
(43) Pub. Date: Nov. 29, 2012

(54) REMOTE CONDITION MONITORING SYSTEM AND METHOD

(75) Inventors: Thomas Schubert, Fort Mill, SC (US); James Ingerslew, Sugarland, TX (US)

(73) Assignee: SCHAEFFLER TECHNOLOGIES AG & CO. KG, Herzogenaurach (DE)

(21) Appl. No.: 13/509,093

(22) PCT Filed: Nov. 11, 2009
(86) PCT No.: PCT/EP10/67289

§ 371 Date: May 10, 2012

(30) Foreign Application Priority Data
Nov. 13, 2009 (US) 61/261229

(51) Int. Cl. G08C 15/06

(52) U.S. Cl. 340/870.02

(57) ABSTRACT

A method of monitoring wind turbines in remote locations, the steps comprising: attaching a first portable condition monitoring (CM) module to a first wind turbine; attaching a second portable CM module to a second wind turbine; carrying out unmanned monitoring the first wind turbine and the second wind turbine based on wireless transmissions from the first CM module and the second CM module; removing the first portable CM module after a predetermined amount of time has passed; and removing the second portable CM module after the first portable CM module has been removed.

### TECHNICAL FIELD

The invention relates to wind turbines and more specifically to condition monitoring equipment and methods used with wind turbines.

### BACKGROUND OF THE INVENTION

Wind turbines are machines used to convert wind power to electrical power. Often, wind turbines use propellers or turbine blades to drive a gearbox, rotor shaft, and a generator (or other mechanical elements) that ultimately produces electricity. After a period of operation, the mechanical elements used by wind turbines may need to be monitored for abnormal behavior, predictive maintenance, or warranty checks. Condition monitoring (CM) equipment can be installed that provides feedback about the operational condition of the wind turbines. However, linking CM equipment to wind turbines can be a labor-intensive task that involves equipment having a wide range of components. This equipment can typically include a processor, non-volatile memory, as well as various sensors that are coupled to the wind turbine or specific components thereof. These sensors can include a speed sensor for measuring turbine speed, accelerometers for measuring vibration, and a current monitor for determining turbine load.

In some cases CM equipment is permanently attached to the wind turbine. But the equipment itself may be costly, especially in applications involving installations that include many wind turbines. And in applications that temporarily install CM monitoring equipment on turbines, installation time can be significant and the data generated during the monitoring period may not be reveal the condition of the wind turbines until a technician physically removes the CM equipment and obtains the data. When monitoring wind turbines, such as wind farms having a plurality of wind turbines, it is beneficial to reduce the amount of CM equipment used to monitor wind turbines as well as the amount of time needed to implement that equipment.

### SUMMARY OF THE INVENTION

In accordance with the invention, there is provided a CM system which includes a plurality of CM modules that can be temporarily installed on a subset of a larger group of wind turbines to gather data about each monitored turbine over a period of time. The equipment used in the CM system can include a remote access (RA) module for each CM module that receives the data from the CM module and wirelessly transmits it in real time to a remote monitoring (RM) station. The CM equipment can be portable and is efficiently rotated between some or all of the wind turbines in the group according to a scheduled process of installation and removal. This permits unmanned monitoring of the group of wind turbines over time without the need for dedicated equipment located at each wind turbine. In one exemplary embodiment, this process involves physically installing (commissioning) the CM equipment on a subset of wind turbines over a period of time (e.g. a number of days). Later, technicians remove (decommission) at least some of the installed CM equipment, which is then moved to wind turbines that have yet to be monitored. The installation and removal of CM equipment is carried out according to a staggered or progressive schedule that is designed so that each wind turbine can be fitted with the CM equipment for a sufficient amount of time to obtain suitable data, but at the same time the amount of CM equipment used for monitoring can be kept to a subset of the total number of wind turbines being monitored. The remote monitoring (RM) stations can determine whether sufficient data has been received based on the data wirelessly transmitted from the CM equipment attached to the wind turbines. The installation and removal of CM equipment—as well as the monitoring of wind turbines using the CM equipment—can continue until each of the wind turbines in the group has been monitored. Then, the process can begin again at the first wind turbine or the process can be rescheduled to begin again after a period of time has passed (e.g. weeks or months).

### BRIEF DESCRIPTION OF THE DRAWINGS

Preferred exemplary embodiments of the invention will hereinafter be described in conjunction with the appended drawings, wherein like designations denote like elements, and wherein:

FIG. 1 depicts a condition monitoring (CM) system for monitoring wind turbines using CM equipment and remote monitoring (RM) stations;

FIG. 2 depicts a block diagram of an embodiment of the CM equipment;

FIG. 3 depicts exemplary components of the CM equipment of FIG. 2;

FIG. 4 depicts an embodiment of a visual display used for remote monitoring of the wind turbines;

FIG. 5 shows examples of speed sensors; and

FIG. 6 shows an exemplary method for monitoring wind turbines.

### DETAILED DESCRIPTION OF THE PREFERRED EMBODIMENTS

Wind turbines, also referred to as wind generators, wind mills, or wind energy converters, transform wind energy into electricity. By placing the wind turbines in areas having significant amounts of wind, electricity can be generated. Various wind turbine designs are possible. Wind turbines include drive shafts that connect turbine blades to a generator. As wind acts on the turbine blades, the drive shaft rotates powering the generator and creating electricity.

In general, the disclosed monitoring system and method uses condition monitoring (CM) equipment to monitor a plurality of wind turbines. The CM equipment for a single wind turbine can include a CM module that includes sensors for measuring turbine operational parameters and a remote access (RA) module that obtains the (processed and/or unprocessed) sensor data from the CM module and transmits it wirelessly to a central facility or other remote monitoring (RM) station. The operational parameters measured by the CM module includes metrics that can involve the mechanical/electrical health of the wind turbines. This can be done for any desired purpose, such as for predictive or preventative maintenance, or for an end of warranty check. Examples of abnormal behavior include excessive vibration generated by the driveshaft of the wind turbine or excessive current draw from the turbine.

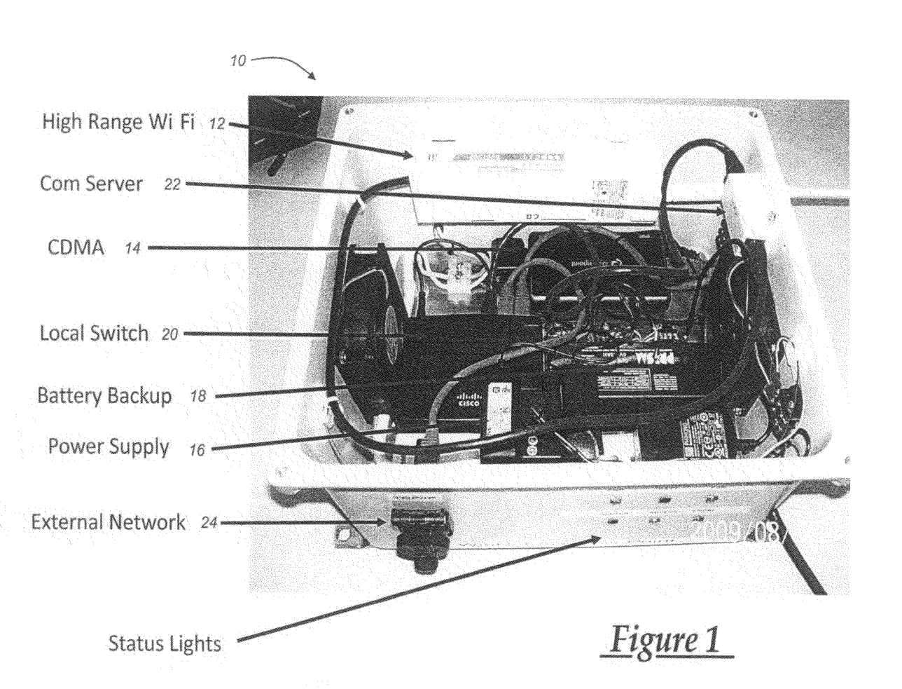

Turning to FIG. 1, there is shown an exemplary system 100 for monitoring wind turbines using the CM equipment and RM stations. The system 100 includes a plurality of wind turbines 110-130, CM equipment 140-160, a first RM station 170, a second RM station 180, and a land network/wireless network 190. The RM stations 170, 180 can be located at nearly any geographical location and communicate with the CM equipment 140-160 via the land/wireless network 190. If desired, only one RM station can be used, two or more can be used. Through the communications, the RM stations 170, 180 can obtain the data generated by the CM equipment 140-160, such as wind turbine vibration data, latitude and longitude coordinates from a GPS receiver, current draw, or temperature. And at the RM stations 170, 180, the generated data can be processed and archived for presentation to a wind turbine owner/operator.

The land network may be a conventional land-based telecommunications network that connects CM equipment 140-160 to RM stations 170, 180. The land network can also use a wireless network for a portion of the communications between a RM station and the CM equipment on any particular turbine. Both the land network and the wireless network are generally shown at 190. The wireless network can also provide communications between the CM equipment 140-160 and the RM stations 170, 180 without the land network. For example, land network may include a public switched telephone network (PSTN) such as that used to provide hardwired telephony, packet-switched data communications, and the Internet infrastructure. One or more segments of the land network could be implemented through the use of a standard wired network, a fiber or other optical network, a cable network, power lines, other wireless networks such as wireless local area networks (WLANs), or networks providing broadband wireless access (BWA), or any combination thereof. The wireless network can be a cellular telephone system that includes a plurality of cell towers, one or more mobile switching centers, as well as any other networking components required to connect the wireless network with the land network.

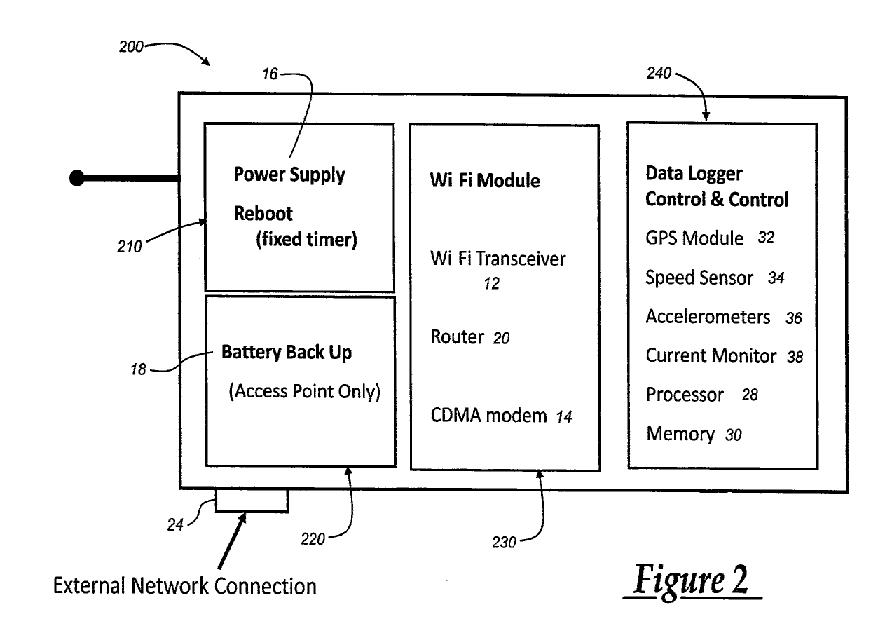

The CM equipment can monitor the wind turbines using speed sensors or other sensors that are permanently incorporated into the wind turbine or that can be incorporated into the CM equipment. As shown in FIG. 2, the CM equipment 140-160 for each turbine includes both a CM module 210 and a remote access (RA) module 240 interconnected together either wirelessly, via a hardwired connection, or by being integrated into a single enclosure or other assembly. In the illustrated embodiment, the modules 210, 240 are interconnected via a hardwired cable, such as a Cat5 cable using TCP/IP in an Ethernet LAN setup to exchange data and commands. CM module 210 generally comprises a conventional condition monitoring unit that includes as its main components a power supply 212, processor 214, memory 216, and various sensors including a turbine shaft speed sensor 218, a plurality of accelerometers 220, and a current monitor 222. The memory 216 can include ROM, RAM, NVRAM, and/or other computer readable memory and can store a control program used by the processor 214 to carry out the most if not all functions of the CM module. As will be appreciated by those skilled in the art, the power supply 212, processor 214, memory 216, speed sensor 218, accelerometers 220, and current monitor 222 can all be hardware components that are commercially available and can be interconnected and controlled via software to obtain vibration and other such acceleration data from various points or components on wind turbines. Other sensors and components can also be used. For example, in lieu of or in addition to shaft speed sensor 218, an optical pickup 224 can be used in conjunction with a turbine shaft speed sensor that is not part of the CM module, but is an existing speed sensor onboard the wind turbine to monitor the speed of the turbine drive shaft as part of wind turbine operation. The existing speed sensor can be of the type that includes a light-emitting diode (LED) that outputs light pulses with a frequency equal or proportional to the rotational speed of the turbine drive shaft. Examples of typical speed sensors are shown in FIG. 5. The speed sensor can be, for example, an inductive type that includes an M12 connector and a plurality of LEDs located on the exterior of the sensor. Alternatively, a glass fiber optic sensor or convergent-mode sensor can be used as shown in FIG. 5. These also include an indicating LED (not shown). Or, any other suitable sensor can be used that provides a detectable optical output that pulses at a rate dependent on the rotational speed of the turbine shaft. As is known, these speed sensors send an electronic signal each time the drive shaft rotates a predetermined distance and also provides a visual indication of this by pulsing the included LED. Thus, rather than including a separate speed sensor 216 as a part of the CM module 210, an optical pickup 224 can be used and positioned to detect the light pulses emitted by the LED. Each time the existing speed sensor activates the LED, the optical pickup 224 detects it and generates a signal of its own. An interface circuit 226 can then be used to filter, amplify, and condition the received pulses from the optical sensor to produce a pulse train having a pulse repetition rate that is representative of the rotational speed of the turbine shaft. In this way, the CM module 210 can determine and record shaft speed. The optical pickup 224 can be a photodiode or other suitable device that is clipped to the speed sensor or otherwise mounted in close proximity to the LED in such a way to accurately receive the light pulses.

The RA module 240 is used as a wireless access node and includes as its main components a power supply module 242, a backup power supply module 244, a Wi-Fi module 246, GPS 248, and a data logger/control module 250. Modules 242-250 can be included together within a housing that is capable of supporting and protecting them from damage. The RA module 240 can be used to provide wireless communication of the sensor data from CM module 210 back to one or both remote monitor (RM) stations 170, 180. The power supply module 242 includes a power supply 243, which is sized in order to be capable of providing electrical power to all of the components of the RA module 240. This power supply module 242 can also include a Reboot function on a fixed timer such as a watchdog timer. In the event that the power supply module 242 cannot provide power to the RA module 240, the backup power supply module 244 includes a battery backup power supply 252 that can supply power to the components of the module 240. As will be appreciated by those skilled in the art, where CM module 210 and RA module 240 are hardwired together as shown, or integrated into a single enclosure, a single power supply (with or without backup) can be used in lieu of the multiple supplies shown.

The Wi-Fi module 246 includes devices capable of sending and receiving data to and from the RA module 240. The module 246 includes a Wi-Fi transceiver 256, a cellular modem 258, cellular transceiver 260, and a router 262. The GPS 248 can be a conventional GPS receiver that provides location-identifying information that can be transmitted back to the RM stations 170, 180 and used there to identify the location of the CM equipment and, thus, the wind turbine itself. The data logger/control module 250 can include a processor and memory and can be connected to the other modules 242-248 to control operation of the RA module 240 as well as log and/or forward at least some of the sensor data.

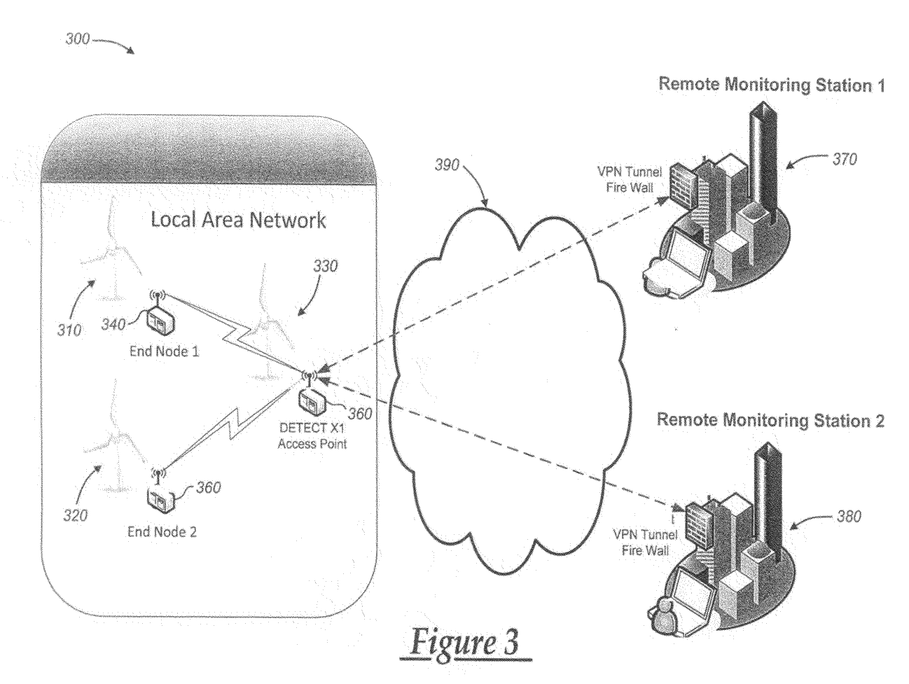

FIG. 3 depicts an exemplary set of CM equipment 160 that includes the CM module 210 and the RA module 240. Most of the various components of the RA module 240 are shown individually. Other components used in the prototype module 240 shown including a com server 266 that provides remote TCP/IP access via, for example, http to configure the CM equipment from the RM stations.

Apart from RA module 240 containing all the components shown in FIGS. 2 and 3, it can be constructed as a secondary node that has only short range wireless capability (e.g., Bluetooth or 802.11) to one or more other RA modules, at least one of which has the cellular modem/transceiver and/or other longer distance (e.g., Wi-Fi, satellite telephone, etc.) communication capability. Thus, for example, as shown in FIG. 1, when a plurality of CM equipment 140-160 are attached to a corresponding plurality of wind turbines, a main RA module 240 can be designated to act as a main or primary node and the RA modules used in the other CM equipment 140, 150 can be designated to act as secondary (end) nodes. Then, in use, data is sent from the end nodes 140, 150 to the main access node 160 which then sends it on to the RM station 170 or 180. Control and other communications from the RM station(s) can likewise be sent to the end nodes 140, 150 via the access node 160. While complicating the communication slightly, this approach eliminates the requirement that each RA module have long range communication capability. Where a particular RA module is used as a secondary node, it can omit not only the cellular communication devices, but also some of the other components of RA module 240, such as the battery backup.

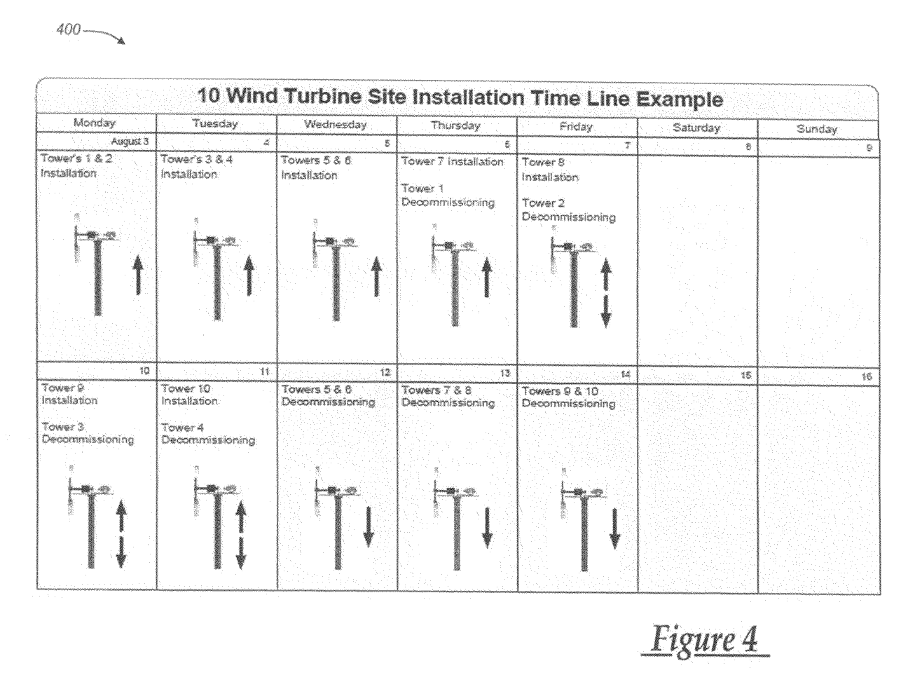

Turning to FIG. 4, the data obtained from the monitored wind turbine can be shown on a visual display 400. FIG. 4 depicts an exemplary graphical user interface generated by software on a computer at the RM stations 170, 180. Each wind turbine can have a data logger screen showing the speed of the turbine, location, communication status, and battery condition. This allows the monitoring manager to know when a new turbine comes on line and what the operating parameters are at all times. In this example, the visual display can indicate a wind turbine owner (in this example ‘KCPL’), a wind turbine identifier (‘0234’), a GPS position of the wind turbine ('L23NE/L121SW), a temperature (‘32’), a power source (‘AC MAINS’), a battery status (‘10.7’), and a status of the CM module cooling fan. Other metrics and data are shown and it should be appreciated that the data shown can be added to or subtracted from depending on the desires of monitoring technicians.

Software at the CM modules and at the remote station can be used to automatically report and display the location information each time the CM equipment is powered up or accessed by a technician from the RM station. A Commissioning button can be included on the user interface as shown in FIG. 4 such that, once activated, the condition monitoring and data logging begins and can be carried on for a desired length of time. A decommissioning clock indicates when the monitoring is scheduled to end, at which point the CM equipment can be removed from the wind turbine and used for subsequent monitoring of another wind turbine. As will be appreciated, as long as the CM equipment is online and in communication with the remote station, the display of FIG. 4 can be made available for review anytime by the technician at the remote station.

Turning to FIG. 6, the CM equipment 140-160 is installed or removed from each of a number of wind turbines based on a progressive schedule. FIG. 6 depicts one example 600 of a monitoring method used to monitor ten wind turbines. In this example, six sets of CM equipment are installed on or removed from ten wind turbines over a period of fourteen days using a crew of technicians capable of installing/removing two sets of equipment per day. On the first day (in this example, August 3), CM equipment is installed on the first and second wind turbines (1-2). The next two days (August 4-5), CM equipment is installed on wind turbines 3-6. The fourth day involves removing the CM equipment from the first wind turbine and installing it on the seventh wind turbine. Over the next three weekdays (August 7 and August 10-11), one set of CM equipment is removed from one wind turbine and installed on another wind turbine. For instance, on August 7, one set of CM equipment is removed from wind turbine 2 and installed on wind turbine 8. On August 10, the CM equipment from wind turbine 3 is removed and installed on wind turbine 9. And on August 11, the CM equipment from wind turbine 4 is removed and installed on wind turbine 10. Now, for the last three days of monitoring (August 12-14), the CM equipment from wind turbines 5-10 are removed. For instance, on August 12, the CM equipment from wind turbines 5 and 6 are removed, on August 13 the CM equipment from wind turbines 7 and 8 are removed, and on August 14 the CM equipment from wind turbines 9 and 10 are removed. If desired, this schedule can be modified during the monitoring period based on the received data. For instance, if one of the RM stations 170, 180 determines that the data it received from the CM equipment installed on wind turbine 1 is insufficient, the schedule can be modified to remove the CM equipment on wind turbine 2 on August 6 and install it on wind turbine 7, while leaving the CM equipment to remain on wind turbine 1 to collect more data. Or the schedule can be modified to leave one or more sets of CM equipment installed on wind turbines longer based on the data the RM stations receive in real time.

Other such rotational schedules will become apparent to those skilled in the art. By using such a method, unmanned monitoring can be conducted for days at a time without requiring permanent equipment installation and without requiring dedicated equipment for each wind turbine.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of monitoring wind turbines in remote locations, the steps comprising:
attaching a first portable condition monitoring (CM) module to a first wind turbine;
attaching a second portable CM module to a second wind turbine;
carrying out unmanned monitoring of the first wind turbine and the second wind turbine based on wireless transmission of data from the first portable CM module and the second portable CM module;
removing the first portable CM module after a predetermined amount of time has passed; and
removing the second portable CM module after the first portable CM module has been removed.

2. The method of claim 1, further comprising the step of providing a first remote access (RA) module connected to the first portable CM module and a second RA module connected to the second portable CM module, and wherein the unmanned monitoring step further comprises transferring the data from each of the portable CM modules to an associated one of the RA modules and then wirelessly transmitting the data from the RA module to a remote monitoring station.

3. The method of claim 2, wherein each of the portable CM modules includes a plurality of sensors that provide the data.

4. The method of claim 1, further comprising the steps of attaching, monitoring, and removing additional portable CM modules to different wind turbines from among a larger group of wind turbines according to a staggered process that involves at least some days during which at least one of the portable CM modules is installed on one wind turbine, at least one of the portable CM modules is removed from the second wind turbine, and at least one of the portable CM modules is monitoring a third wind turbine.
